(19) United States
(12) Patent Application Publication
(10) Pub. No.: US 2016/0316712 A1
(43) Pub. Date: Nov. 3, 2016

(54) LIVESTOCK PRODUCTION FACILITY

(71) Applicant: KEE3, LLC, Warren, IN (US)

(72) Inventor: Greg Kratzer, Warren, IN (US)

(21) Appl. No.: 15/143,952

(22) Filed: May 2, 2016

Related U.S. Application Data
(60) Provisional application No. 62/155,682, filed on May 1, 2015.

(51) Int. Cl. A01K 1/015; C02F 11/00; C05F 3/00; A01K 1/01

(52) U.S. Cl. CPC A01K 1/0151; A01K 1/0103; C02F 11/00; C05F 3/00; C02F 2103/20

(57) ABSTRACT

A livestock barn is provided including a pit. A first portion of a pit floor slopes downward from a first side of the pit to a centerline of the pit and a second portion of the pit floor slopes downward from a second side of the pit to the centerline so that excrement on the first portion of the pit floor and excrement on the second portion of the pit floor is directed toward the centerline. The pit floor is sloped downward from a first end of the pit to a second end of the pit so that excrement on the centerline is directed from the first end to the second end.

### CROSS-REFERENCE TO RELATED APPLICATIONS

The present application is a non-provisional patent application of, and claims priority to, U.S. Provisional Patent Application Ser. No. 62/155,682, filed May 1, 2015, and having the title “LIVESTOCK PRODUCTION FACILITY”, which is herein incorporated in its entirety by reference.

### TECHNICAL FIELD OF THE DISCLOSED EMBODIMENTS

The embodiments herein generally relate to farming and, more particularly, to a livestock production facility.

### BACKGROUND OF THE DISCLOSED EMBODIMENTS

Generally, livestock production facilities include a pit positioned beneath a pen for the livestock. The pit is configured to capture excrement from the livestock that is passed through slots in the pen floor. Typically, the excrement in the pit accumulates seasonally, often over several months to a year, before the pit is emptied. Allowing the excrement to accumulate may cause significant odor which may be harmful to the livestock housed within the production facility and offensive to those working on the farm or living nearby. Additionally, the accumulation of excrement may cause the production of unwanted gases in the excrement and an accumulation of such gases, resulting in uncontrolled gas releases within the livestock barn. This accumulation and release of gases could potentially result in an explosion that may be harmful, or even fatal, to the livestock and/or farm workers. Moreover, by allowing the excrement to accumulate, the pit becomes increasingly fetid, anaerobic, and potentially disease ridden. As such, the housed livestock may be exposed to hazardous health conditions. The process of cleaning the pit may become more time consuming and costly the longer the excrement is held before the disposal of the accumulated manure. For example, cleaning one livestock barn may require the disposal of as much as approximately one and a half million gallons of accumulated excrement, and the use and disposal of many thousands of gallons of fresh water to wash the retention pit before the next cycle of accumulation.

Also, excrement from livestock barns is very often incapable of being reused due to bacteria within the excrement. Many diseases affecting the livestock may be similar to those affecting humans, and this may prohibit or restrict the reuse of the excrement. The large volume of excrement may have to be only used on the limited adjacent/nearby fields where it may be spread as a natural fertilizer. However, repeated use of the very large volumes on these nearby fields may cause an overload of the nutrients, saturate the soil, and render the fields incapable of accepting the continued high volumes of accumulated excrement. With this saturation, the excess excrement may be naturally conveyed into a pond, or other waterway, thereby potentially causing pollution, and possibly contamination of the local water supply. Periodic use of the excrement in smaller volumes could be better managed, but since farming practices make application of this excrement only possible when the ground is not frozen, when the ground is not flooded or too wet from recent rains, and when there are no crops on the land, there are only brief, short, periods of seasonal opportunity for proper excrement disposal. With the very large volumes of annually accumulated excrement, this task over a few days is enormous, requiring hundreds of truckloads.

A need remains for more frequent disposal or application of this excrement. To accomplish this, a livestock barn that can be more frequently cleaned to prevent the accumulation of excrement or a method of removing excrement regularly from existing barn designs is required. Another need remains for a method to produce a useable product from the excrement removed from a livestock barn. Because the additional equipment and process may increase the capital required, there will need to be new revenue to support the additional investment and the potentially higher operating expense. Another need remains to provide both savings and increased revenue, and to retain and enhance the earnings potential of the farm.

### SUMMARY OF THE DISCLOSED EMBODIMENTS

In at least one embodiment, a livestock barn having a pit with sloped floors is provided. In at least one embodiment, an existing barn pit may be nearly drained, and then some water may be added to facilitate the daily extraction of excrement. In one embodiment, the pit is partially filled with a shallow pool of water to capture excrement. This shallow pool keeps the new excrement in water to retain the moisture in the solids and to suppress the odor that would be present if excrement were to remain on a bare floor. On a bare floor, the solids may dry, and then be more difficult to move with the flow of the pool draining away, even if supplemented by powerful water jets. In an embodiment with a shallow pool, moist solids may remain soft enough to pass with the draining water into the conveying drain, and then on into the main flow pipe to be processed daily. In one embodiment, the livestock barn has a drain at the lowest portion of the sloped floor, located in the deepest part of the shallow pool, to flush excrement from the pit as the water rushes to the deeper water drain in the shallow pool. In one embodiment, the livestock barn has a water system to supplement the flush of the sloped floor of the pit so that the water and the excrement are forced into the drain. In one embodiment, the water system partially refills the pit after the pit has been flushed. The strong water jets used to boost the flush flow, are also used to refill the shallow pool quickly back to proper initial water levels. This powerful refill jet action will also encourage any remaining solids toward the deep center area toward the drain to be moved in the next flush. In one embodiment, the water system uses sanitized, recycled water from the pit. This reuse of the water limits the amount of fresh water required to replenish the standing shallow pool, making the flush system more water conservative, and with the daily flush with sanitized water, it limits the potential for disease transmission. Daily flush and no long term retention can enable a cleaner living environment for the livestock.

In one embodiment, the fresh slurry of solids and water directly from the daily flush of an existing barn pit, or the flush barn of the disclosed embodiments, are sent through an industrial grinder to render the new fresh solids to a more consistent particle size to facilitate further processing. In one embodiment, a method of separating this fresh solid waste from recovered water is provided. Several processes could provide this separation, including belt press equipment, screw press equipment, centrifuge equipment, rotary press equipment, or solid/liquid de-watering equipment designed specifically to operate without polymer or coagulation required. Now separated, the water is processed further by a set of water purification equipment, and the solids are processed further by a corresponding set of solids processing equipment to eliminate pathogens, and to process the solids to a fuel or a soil supplement.

The embodiments described herein include a water sanitization and value adding process. In one embodiment, the method includes adding microbes to the recovered water after the water has been micro filtered, settled in holding tanks, and concentrated and purified by a reverse osmosis process. Several devices may be utilized to provide micro filtration and reverse osmosis purification to condense the nutrients to prepare it to receive the microbes to create another product for plant growth promotion. Several processes may be used to further purify the water for re-use. These processes may include ozone injection, induction heating, and ultraviolet light emitting diode exposure, to name a few. Nitrogen and/or phosphorus extraction isolates the organic nitrogen and phosphorus for later use or sale. Bio-char may be inoculated with the remaining water still having some nitrogen and phosphorus, to use as a microbe carrier to the soil, ready to enhance growth and soil quality. This water conversion revenue is important for the justification of the capital investment. Excess water is returned to the barn to either dilute or flush the excrement.

The embodiments described herein include a solids sanitization and value adding process. In one embodiment, the method includes pulverizing the solid waste after the separation from the majority of the water. This pulverizing action will remove additional water from the solids, and will have a pathogen killing effect from the residence of the solids in the pulverizing zone. This now improves the solids to be nearly pathogen free, for use as a natural soil supplement and for transportation beyond the immediate vicinity of the livestock facilities. This facilitates providing improved environmental management practices throughout the year, and eliminates the need to land apply manure during unfavorable soil conditions or crop interval timing. The upgraded solids material may be blended with other natural livestock (or fish) manures to engineer a natural soil supplement. In one embodiment, the method includes adding microbes and/or other additives, for example mycorrhizae, bio-char, and/or minerals, to the solid waste. This blended material may then be pelletized for transport and odor free handling for a wide range of row crop uses, for example vegetable and fruit growing for both commercial use and for personal use.

In one aspect, a livestock barn is provided including a pen for housing livestock and a pit for capturing excrement. A barn floor is positioned between the pen and the pit. The barn floor has openings therein so that excrement within the pen falls through the openings into the pit. The pit includes a first end and an opposite second end. The pit also includes a first side and an opposite second side. The first side and the second side extend between the first end and the second end to define the pit. A pit floor extends between the first end and the second end and extends between the first side and the second side to define a bottom of the pit. A centerline extends along the bottom of the pit between the first end and the second end. The centerline is substantially equidistant from the first side and the second side. A first portion of the pit floor slopes downward from the first side to the centerline and a second portion of the pit floor slopes downward from the second side to the centerline so that excrement on the first portion of the pit floor and excrement on the second portion of the pit floor is directed toward the centerline. The pit floor is sloped downward from the first end to the second end so that excrement on the centerline is directed from the first end to the second end.

In one aspect, a method of cleaning a livestock barn is provided. The livestock barn has a pit for capturing excrement and a pit floor extending between a first end of the pit and a second end of the pit and extending between a first side of the pit and a second side of the pit to define a bottom of the pit, wherein a centerline extends along the bottom of the pit between the first end and the second end and is substantially equidistant from the first side and the second side. The method includes sloping a first portion of the pit floor downward from the first side to the centerline so that excrement on the first portion of the pit floor is directed toward the centerline. The method also includes sloping a second portion of the pit floor downward from the second side to the centerline so that excrement on the second portion of the pit floor is directed toward the centerline. The method also includes sloping the pit floor downward from the first end to the second end so that excrement on the centerline is directed from the first end to the second end.

In one aspect, a method for processing a slurry of water and solids is provided. The method includes grinding the slurry to reduce a particle size of the solids. The method also includes separating the water and solids to create separated water and separated solids. The method also includes adding microbes to the separated water. The method also includes pulverizing the separated solids to create pulverized solids. The method also includes mixing the pulverized solids with supplementary enhancements to create mixed solids. The method also includes pulverizing the mixed solids to create a powder. The method also includes mixing the powder with at least one of supplements, bio-char, microbes, and mycorrhizae to create a soil supplement.

Other embodiments are also disclosed.

### BRIEF DESCRIPTION OF DRAWINGS

The embodiments described herein and other features, advantages and disclosures contained herein, and the manner of attaining them, will become apparent and the present disclosure will be better understood by reference to the following description of various exemplary embodiments of the present disclosure taken in conjunction with the accompanying drawing, wherein:

FIG. 1 is a side perspective view of a livestock production facility in accordance with an embodiment.

FIG. 2 is a top perspective view of a section of the livestock production facility with a portion of the roof and a portion of the floor removed.

FIG. 3 is a top perspective view of a portion of the section of the livestock production facility having a portion of the floor removed.

FIG. 4 is a side perspective view of a water main service in accordance with an embodiment.

FIG. 5A illustrates a flowchart for separating and sanitizing waste solids and water.

FIG. 5B is a continuation of the flowchart shown in FIG. 5A.

FIG. 5C is a continuation of the flowchart shown in FIG. 5A.

FIG. 5D is a continuation of the flowchart shown in FIG. 5A.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

At least one embodiment provides a new building for a livestock production facility. This embodiment provides for daily removal of excrement through flushing, which may minimize odors and gases within the livestock production facility, thereby enhancing the workplace for farm workers and owners. Additionally, this embodiment may improve living conditions and promote better health for both the livestock and those living on, and near, the farm. This embodiment also complies with current environmental practices and may reduce the costs associated with barn permits and compliance. In this embodiment, water and solids in the waste are separated, sanitized and reused. Excess water may be returned for irrigation, to a pond, a water tank, receiving body, or the like.

In at least one embodiment, an existing livestock production facility is retrofitted to improve efficiency in waste removal, and permit the frequent, such as daily, processing of the daily contribution of livestock excrement. There may be a large quantity of existing accumulated excrement to be processed before the daily extraction is adequate to empty and recharge the pit, and the daily accumulation ceases. This embodiment allows for the daily removal of waste at a rate higher than the daily production of new manure in order to process both the daily production and a portion of the accumulated excrement in the pit. After the accumulated excrement is processed, the near empty pit can be flushed daily and the removal of excrement will be reduced to the daily volume produced. In this embodiment, water and solids in the waste are separated, sanitized and reused. Excess water may be returned for dilution in the pit, irrigation, to a pond, a water tank, receiving body, or the like.

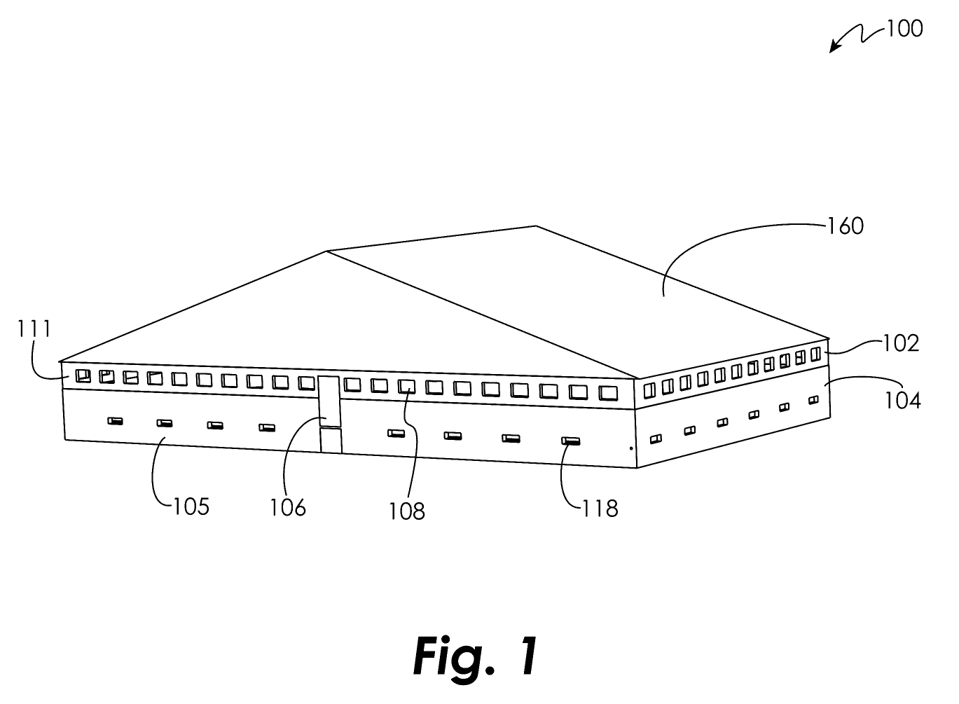

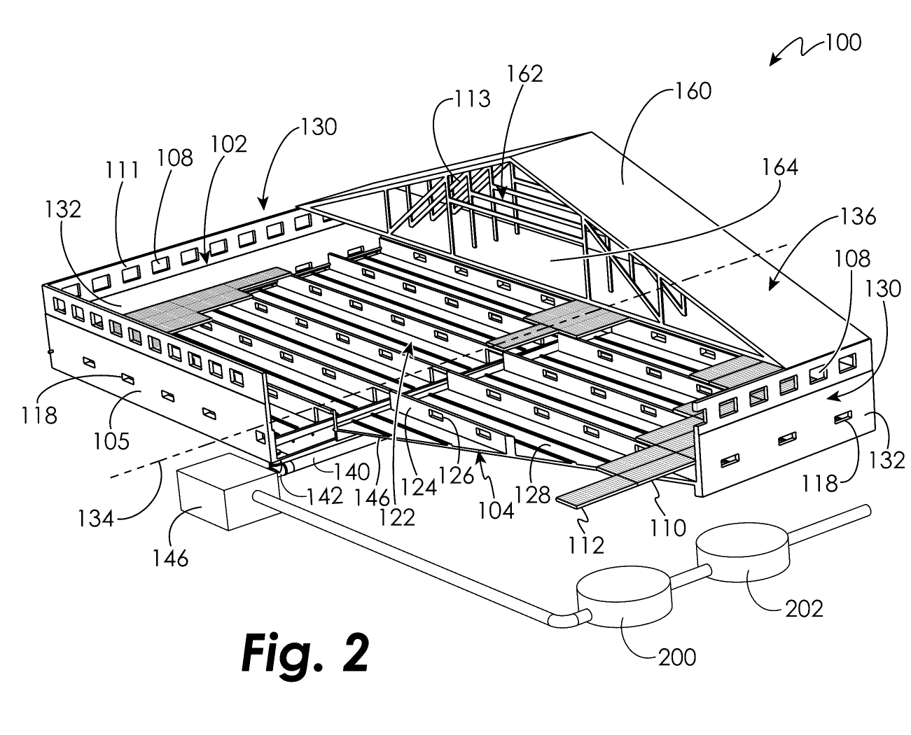

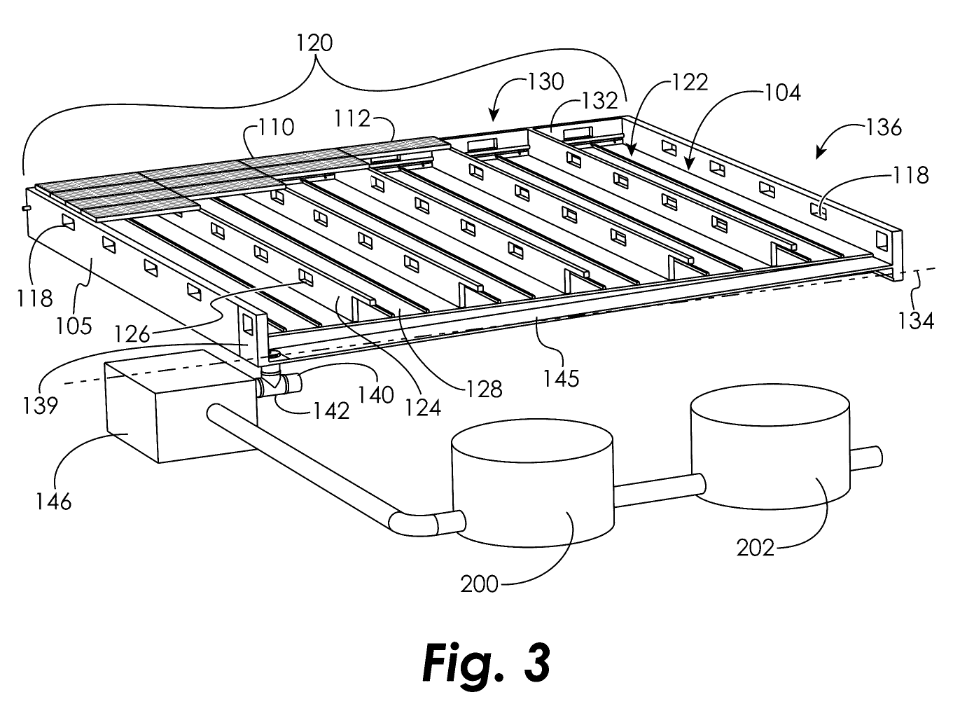

FIGS. 1-4 illustrate a livestock production facility 100 having a pen 102 for retaining livestock and a pit 104 positioned below the pen 102. In one embodiment, the livestock production facility 100 has inside measurements of approximately 108′ wide by approximately 360′ long. It will be appreciated by one of skill in the art that any dimensions may be utilized for the livestock production facility 100. In some embodiments, the design anticipates a modular concept to facilitate modifications to the basic module to achieve a variety of building sizes for various herd sizes. It is intended to permit modification to the size of the modules to retain the integrity of the flush design. In one embodiment, the pit 104 is positioned partially below ground. In another embodiment, the pit 104 is positioned above ground. The pit 104 may be formed from concrete or any other suitable building material capable of retaining water, and providing structural support. The pen 102 may be formed from wood or any other suitable building material. The pen 102 includes doors 106 formed therein to load and unload livestock into and out of the pen 102. In one embodiment, the doors 106 are positioned to be level with a bed of a truck so that the livestock can be transported directly between the truck and the pen 102 at an approximately consistent elevation. In another embodiment, a sloped path extends between the door 106 and the ground. In one embodiment, windows 108 are formed in the walls of the pen 102 to allow natural light to enter the pen 102. In one embodiment, the windows may be opened for ventilation in warm/hot weather.

A floor 110 extends between the pen 102 and the pit 104. In one embodiment, the walls 105 of the pit 104 rise approximately four feet above the floor 110. In one embodiment, walls 111 of the pen 102 rise approximately five feet to truss frames 113 for a ceiling height inside the pen 102 of over approximately eight feet. It will be appreciated by one of skill in the art that any dimensions may be utilized for the livestock production facility 100. The floor 110 is formed from a plurality of floor boards 112 having spaces (such as slotted spaces, to name just one non-limiting example) formed therethrough. When livestock in the pen 102 urinate, the urine falls through the slotted spaces in the floor boards 112 into the pit 104. When livestock in the pen 102 defecate, a portion of the manure falls through the slotted spaces in the floor boards 112 into the pit 104 and a portion of the manure is collected on the floor boards 112. As the livestock walk across the floor boards 112, manure on the floor boards 112 is broken into small pieces that fall through the spaces in the floor boards 112 and into the pit 104.

The walls 105 of the pit 104 may include openings 118 therein to allow airflow from the pit 104 by maintaining a positive pressure within the livestock production facility 100. In one embodiment, the pit 104 includes six sections 120. This sectioning is for the purpose of defining the specific flush areas to be individually flushed and refilled in sequence until all sections are flushed and refilled. The quantity of water in the shallow pool of each flush area is matched to the flow rate of the process equipment in each stage of the water and solids processing. It will be appreciated by one of skill in the art that any number of sections 120 may be utilized. In one embodiment, each section 120 includes six bays 122. It will be appreciated by one of skill in the art that any number of bays 122 may be utilized. Each adjacent bay 122 is separated by a wall 124 having openings 126 therein. The openings 126 enable airflow through the pit 104. The walls 124 provide segregation of collected excrement from excrement in the adjacent bays, limiting the potential transmission of disease from the excrement to only the livestock located above the specific bay 122, this segregation may protect the remaining livestock in the production facility from disease. In one embodiment, each bay 122 includes three channels 128, wherein each channel 128 is separated from adjacent channels 128 by barriers to contain liquids and solids within a channel 128. It should be appreciated that any number of channels 128 may be utilized.

Each section 120 includes two sides 130, wherein a bottom surface of each side 130 is sloped downward from an outer side wall 132 of the pit 104 to a centerline 134 of the pit 104. In one embodiment, the section 120 slopes approximately three inches from each side wall 132 to the centerline 134. Each bay 122 likewise slopes downward from the outer side walls 132 to the centerline 134. Additionally, each channel 128 likewise slopes downward from the outer side walls 132 to the centerline 134. Liquids and solids within each channel 128 will therefore be urged toward the centerline 134 by means of gravity. The walls 124 and the barriers between the channels 128 do not extend all the way to the centerline 134, thus leaving an open channel along the centerline 134. The end walls of each section 120 are fully to the floor in some embodiments, and are waterproof to retain the shallow pool within the specific section 120. This waterproofing facilitates the draining and refilling of each section 120 and may not compromise any adjacent section 120. The center drain may be a large dimension polyvinyl chloride (PVC) pipe with intermittent vertical extensions to receive the draining water from the shallow pool into the center PVC pipe, and on to the following process. This center PVC main drain may slope thru its full length to provide a gravity flow discharge.

A first end 136 of each section 120 has a height that is greater than a second end 138 of the section 120. The centerline 134 therefore slopes from the first end 136 of the each section 120 to the second end 138 of the section 120. In one embodiment, the centerline 134 slopes approximately 15 inches from the first end 136 of the section 120 to the second end 138 of the section 120. Liquids and solids within the centerline 134 may therefore be urged toward the second end 138 of the section 120 by means of gravity.

As the centerline 134 traverses each section 120 in the pit 104, the centerline 134 slopes downward from a first end of the livestock production facility 100 to a second end of the livestock production facility 100. In particular, the second end 138 of a first section 120 has a height that is approximately equal to the first end 136 of an adjacent section 120. Accordingly, the sections 120 are arranged by height from the first end of the livestock production facility 100 to the second end of the livestock production facility 100. Liquids and solids within the centerline 134 are prevented from flowing to the adjacent section 120 by the waterproofed end walls dividing each section 120, and by the exterior wall for each end section 120. In one embodiment, there is no water seepage between the separate sections 120.

A drainpipe 140 extends under the centerline 134 of the pit 104. In one embodiment, the drainpipe 140 is an approximately 18 inch PVC pipe. It will be appreciated by one of skill in the art that any dimensions and materials may be utilized for the drainpipe 140. The drainpipe 140 is sloped downward with the centerline 134 from a first end of the livestock production facility 100 to a second end of the livestock production facility 100. A drain 142 positioned at the second end 138 of each section 120 and is in flow communication with the drainpipe 140. The drain 142 includes a seal that is actuated between an open position and a closed position. In one embodiment, the seal is positioned level with a bottom 145 of the pit 104. A collection tank 146 is positioned at the downstream end of the drainpipe 140. Liquids and solids within the centerline 134 of each section 120 will therefore be directed toward the drain 142 of the section 120 by gravity, and liquids and solids within the drainpipe 140 will be directed toward lowest end of the livestock production facility 100 by means of gravity. The flow of each floor area directly above the PVC center pipe may be supplemented by a water jet to enhance the final flow toward the section 120 drain.

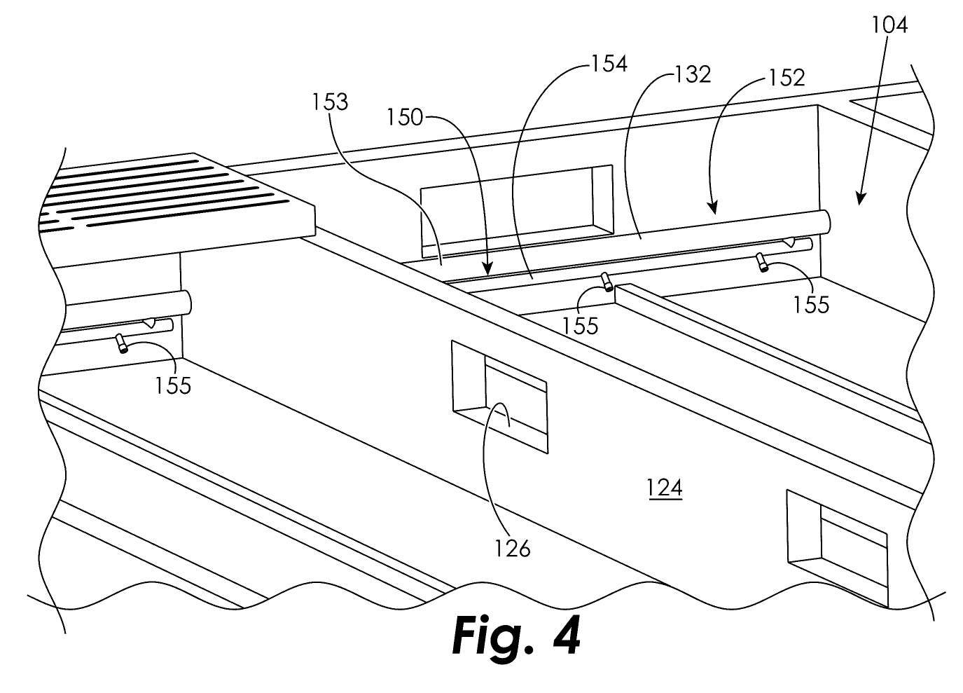

A water jet system 150, shown in FIG. 4, extends along each outer wall 132 adjacent a top 152 of the pit 104. In the illustrated embodiment, the water jet system is high on the outer wall. In another embodiment, the positioning may be lower and below the outside opening to permit more direct long jet nozzles thru each channel toward the center drain area floor. The system 150 includes a water main service 153 feeding a manifold 154 positioned in each bay 122. A valve (not shown) allows water in the water main service 153 to be controllably coupled or uncoupled to the manifold 154. The manifold 154 includes a plurality of nozzles 155. At least one nozzle 155 is aligned with each channel 128. In one embodiment, the nozzles 155 are positioned below the openings 118. The nozzles 155 are configured to eject a high pressure spray of water to supplement the flushing action of the pit 104 to move solids toward the drain 142. Additionally, the nozzles 155 are configured to refill the pit with water to a predetermined height when the drain 142 is closed.

The livestock production facility 100 includes a roof 160 that defines an attic space 162 between the roof 160 and a ceiling 164 of the pen 102. In one embodiment, the attic space 162 houses a heating, ventilation, and air conditioning (HVAC) system (not shown). The HVAC system forces airflow downward from the pen 102 to the pit 104. The air in the pit 104 circulates through the openings 126 and out of the pit 104 through the openings 118. In this manner, the amount of gases and odors transferred from the pit 104 to the pen 102 may be minimized.

During operation, the drains 142 in each section 120 are closed and the pit 104 is filled with water to a predetermined height (approximately 1 to approximately 4 inches deep in one embodiment). Livestock urine and manure passes thru slotted floor 110. The water in the pit 104 collects the urine and manure from the livestock, while also mitigating the smell from the urine and manure. The water abates odor because the liquids and solids are suspended in the water. In one embodiment, the pit 104 is drained daily. In other embodiments, the pit 104 is drained at other intervals. When the pit 104 is ready to be emptied, the drain 142 in the highest section 120 is opened so that the water containing urine and manure flows toward the centerline 134 and collects in the drainpipe 140 via the drain 142. In such an embodiment, the flow of water to the drain 142 is assisted by gravity so that manure solids are carried with the water to the drain 142. The water/urine/manure mixture flows downstream through the drainpipe 140 to the collection tank 146, assisted by gravity. After the water has been drained from the section 120, the nozzles 155 spray high pressure water down each channel 128 to clear any manure or other waste left in the channel 128 into the drain 142. The drain 142 is closed and the nozzles 155 are then actuated to refill the section 120 of the pit 104 with water. An electronic monitor/controller may be used to stop the water flow when the shallow pool in each section 120 is at the proper level. Once the highest section 120 has been cleaned, the next adjacent section 120 is cleaned in the same manner until each section 120 has been cleaned. The flush/drain/refill cycle is continued until each section 120 has been flushed, drained, and refilled.

In one embodiment, the drained water and manure is held in a suspense tank 200 (see FIG. 1). The suspense tank 200 may have a capacity of approximately 10,000 gallons in one embodiment. In one embodiment, the process flow rate may be approximately 100 gallons per minute. In one embodiment, the process capacity may be approximately 6,000 gallons per hour. In one embodiment, the process may take less than 2 hours to flush/drain/refill each section 120. In one embodiment, the process may take approximately 10 hours per livestock production facility 100.

In one embodiment, the drained water in the suspense tank is separated from the solid waste and sanitized before being delivered to a holding tank 202. In one embodiment, the holding tank 202 has a capacity of approximately 10,000 gallons. The water in the holding tank 202 is supplied to the water main service 153 to flush and refill each section 120. In one embodiment, gravity and supplemental pumps provide water pressure to nozzles 155. In one embodiment, supplemental water may be added to the holding tank 202 to offset water loss and evaporation.

In one embodiment, the livestock barn 100 may be automated through a control system (not shown). In one embodiment, the control system may be housed in a separate building from the livestock barn 100. In one embodiment, the control system controls operation of the drains 142 and the water main service 154. In one embodiment, the control system is set to operate the livestock production facility 100 on a timer.

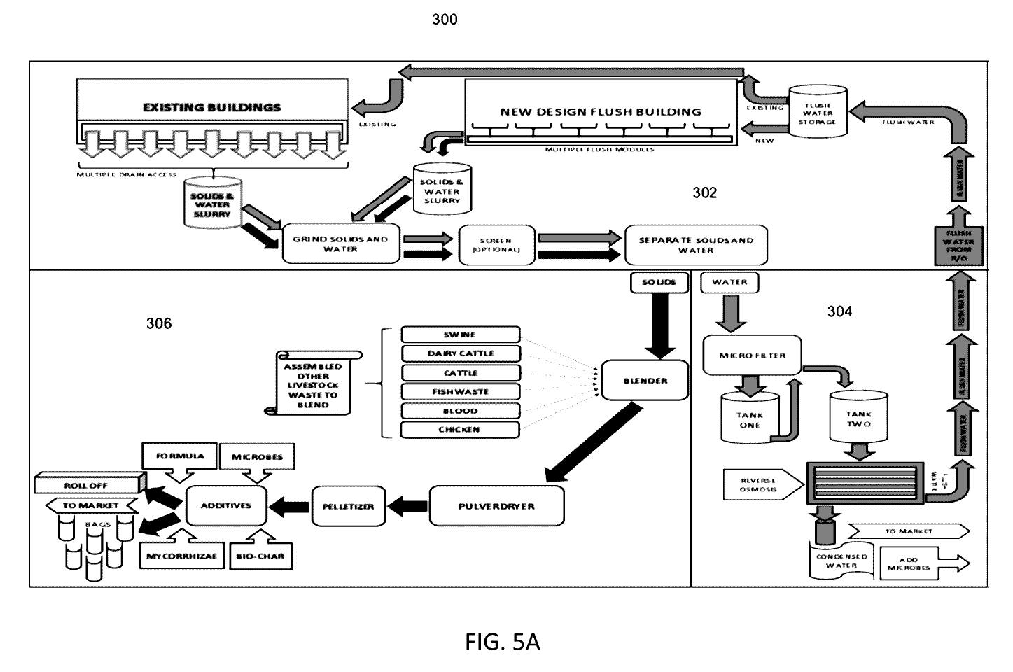

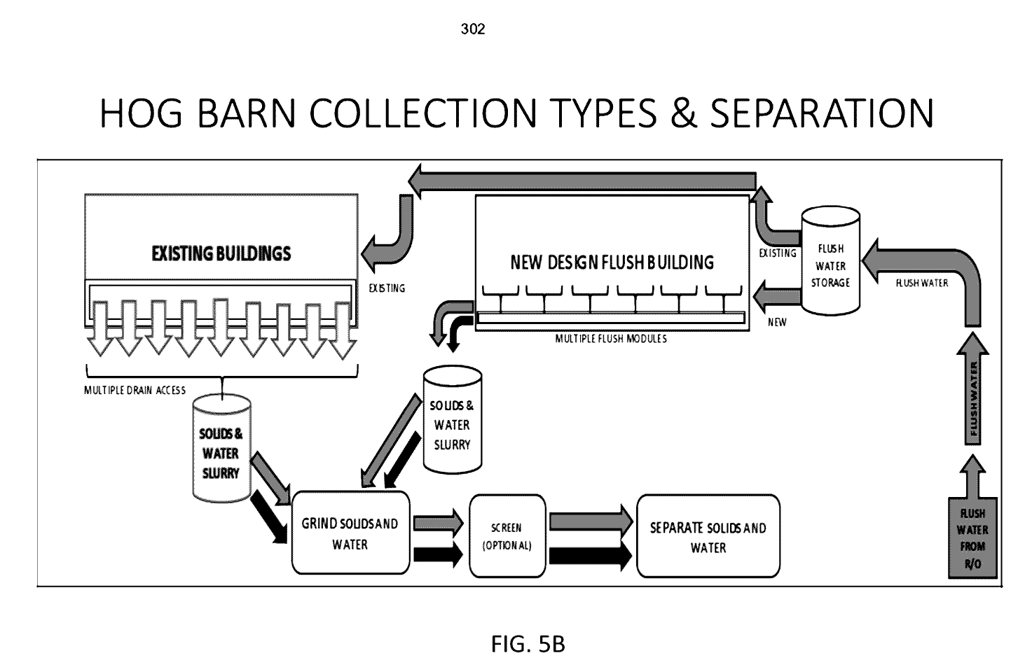

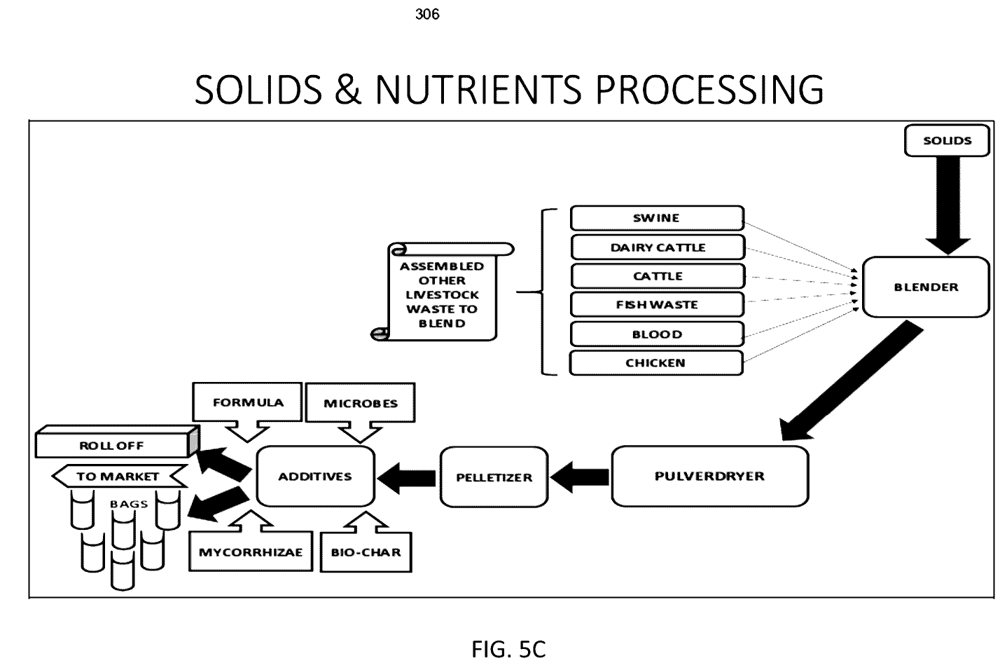

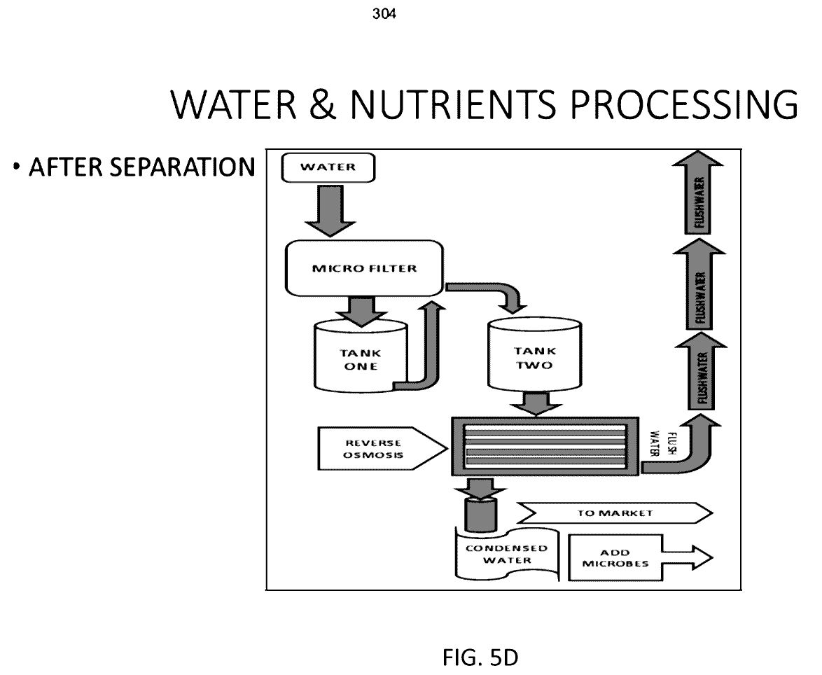

In one embodiment, illustrated in FIG. 5, a method 300 is provided for processing the drained water and manure. In one embodiment, the fresh slurry of solids and water directly from the daily flush of the pit are sent through an industrial grinder to render the new fresh solids to a more consistent particle size to facilitate further processing. In one embodiment, a method of separating this fresh solid waste from recovered water is provided (302). Several processes could provide this separation, including belt press equipment, screw press equipment, centrifuge equipment, rotary press equipment, or solid/liquid de-watering equipment designed without polymer or coagulation required. Now separated, the water is processed further by a set of water purification equipment, and the solids are processed further by a corresponding set of solids processing equipment.

The embodiments described herein include a water sanitization and value adding process (304). In one embodiment, the method includes adding microbes to the recovered water after the water has been micro filtered, settled in holding tanks, and condensed and purified by a reverse osmosis process. Several devices may provide micro filtration, and reverse osmosis purification and can condense the nutrients to receive the microbes to create another product for plant growth promotion. In one embodiment, several processes may be used to further purify the water for re-use. These processes may include ozone injection, induction heating, and ultraviolet light emitting diode exposure, to name a few. Nitrogen and/or phosphorus extraction isolates the organic nitrogen and phosphorus for later use or sale. Bio-char may be inoculated with the remaining water still having some nitrogen and phosphorus, to use as a microbe carrier to the soil, ready to enhance growth and soil quality. This water conversion revenue is important for the justification of the capital investment. Excess water is returned to the barn to either dilute or flush the excrement.

The embodiments described herein also include a solids sanitization and value adding process (306). In one embodiment, the method includes pulverizing the solid waste as after the separation from the majority of the water. This pulverizing action will remove additional water from the solids, and will have a pathogen killing effect from the residence of the solids in the pulverizing zone. This may facilitate the solids to be nearly pathogen free, for use as a natural soil supplement and for transportation beyond the immediate vicinity of the livestock facilities. This facilitates environmental management practices throughout the year, and may eliminate the need to land apply manure during unfavorable soil conditions or crop interval timing.

The separated solid waste may be mixed with supplementary enhancements. In one embodiment, the supplementary enhancements may include beef and dairy cattle waste, poultry waste, fish waste, blood, mycorrhizae, microbes, bio-char, and other materials. The mixed solid waste is then blended, pulverized and dried. In one embodiment, the pulverizing process may kill pathogens and bring the solid waste to a fine textured powder at approximately 65% to approximately 85% solids. The textured powder may be used to blend with supplements, bio-char, microbes, and mycorrhizae. In one embodiment, the pulverizing process may reduce animal manures to a fine dry powder, which is substantially free of both pathogens and offensive odors. In this dry state (approximately 10% moisture), the odor is substantially reduced, and the manure can be stored, efficiently transported, and sold as a fertilizer. The manure may be blended, at the time of production, with a variety of other minerals and chemicals for manufacture of custom fertilizers. Once processed, the manure can also be applied in a greenhouse, or be used as a fertilizer for planting. The pulverizing process enables pathogen reduction and drying of animal waste to approximately 85% solids.

In one embodiment, the method includes adding microbes to the solid waste. Microbes are capable of breaking down organic material into more usable forms that plant roots can identify, absorb, and ultimately incorporate for new growth. The presence of microbes ensures that nutrients are made available to plants at a healthy, productive soil steady rate. While the plants are actively growing, and requiring more nutrients, so do the soil microbes. As the weather warms, the microbes become increasingly active in their role of breaking down organic materials into forms more readily absorbed by the growing plants needing extra nutrition. As the weather cools, and plants require less nutrition, so do the microbes. The reduction in microbe activity means fewer nutrients in the soil are being released to the plants. This self-regulating cycle generates healthy productive soil.

Mycorrhizal fungi increase the surface absorbing area of roots approximately 100 to approximately 1,000 times, thereby facilitating the ability of the plant to access soil resources. Several miles of fungal filaments can be present in less than a thimbleful of soil. Mycorrhizal fungi increase nutrient uptake not only by increasing the surface absorbing area of the roots, but also by releasing powerful enzymes into the soil that dissolve hard-to-capture nutrients, such as organic nitrogen, phosphorus, iron and other “tightly bound” soil nutrients. This extraction process is particularly important in plant nutrition and explains why non-mycorrhizal plants require high levels of fertility to maintain their health. Mycorrhizal fungi form a web that captures and assimilates nutrients, conserving the nutrient capital in soils.

The disclosed embodiments may convert a disposal and/or reuse problem into a revenue generating product as a natural soil supplement enhanced by growth enhancing microbes, and other engineered/selected additives. Water is processed to be a clean revenue source and a sanitized flush water to facilitate the excrement handling process. Solids are sanitized to be nearly pathogen free, and of a quality to be blended with other natural manures with high nutrient value to become an engineered final product where microbes and other additives make a combined product for additional revenue.

The embodiments described herein separate and processes livestock excrement solids in a manner that sanitizes the final product, eliminates odor, and kills pathogens. The embodiments described herein permit blending the livestock excrement with other animal waste to produce a natural soil supplement desirable for vegetables and/or fruits. The embodiments described herein enable farmers to seek greenhouse operators, hydroponic growers, and fish farmers to provide them water with select microbes. Additionally, farmers may determine that operating their own greenhouses or fish farms may provide business opportunities. The embodiments described herein provide livestock farmers with a revised operation concept that provides a new source of revenue by both saving and generating money. The embodiments described herein enable current process designs to be modified to improve daily operations to facilitate achieving improved financial savings, increased revenues, and increased profits. The embodiments described herein promote efficiency, new products, and new logics. The embodiments described herein provide variations for both existing buildings and for new buildings with the design described above. The embodiments described herein facilitate providing improved livestock pen arrangements, improved receiving and loading, automated feeding and watering via master controls, improved exterior loading rooms and docks, exterior operations buildings with water & electronics, and a “livestock considerate” environment designed for health.

While the embodiments have been illustrated and described in detail in the drawings and foregoing description, the same is to be considered as illustrative and not restrictive in character, it being understood that only certain embodiments have been shown and described and that all changes and modifications that come within the spirit of the embodiments are desired to be protected.

What is claimed is:

1. A livestock barn comprising:
a pen for housing livestock;
a pit for capturing excrement; and
a barn floor positioned between the pen and the pit, the barn floor having openings therein so that excrement within the pen falls through the openings into the pit,
wherein the pit further comprises:
a first end and an opposite second end;
a first side and an opposite second side, wherein the first side and the second side extend between the first end and the second end to define the pit;
a pit floor extending between the first end and the second end and extending between the first side and the second side to define a bottom of the pit; and
a centerline extending along the bottom of the pit between the first end and the second end and being substantially equidistant from the first side and the second side,
wherein a first portion of the pit floor slopes downward from the first side to the centerline and a second portion of the pit floor slopes downward from the second side to the centerline so that excrement on the first portion of the pit floor and excrement on the second portion of the pit floor is directed toward the centerline, and
wherein the pit floor is sloped downward from the first end to the second end so that excrement on the centerline is directed from the first end to the second end.

2. The livestock barn of claim 1 further comprising a drainpipe extending along the centerline, the drainpipe having valves intermittently positioned between the first end and the second end so that excrement directed toward the centerline is directed into the drainpipe via the valves, and wherein excrement directed from the first end to the second end is directed through the drainpipe to an outlet at the second end.

3. The livestock barn of claim 2, wherein the valves are operable between an open position and a closed position, wherein, in the open position, excrement is directed into the drainpipe.

4. The livestock barn of claim 2 further comprising a collection tank fluidly coupled to the outlet of the drainpipe, the collection tank collecting excrement from the drainpipe.

5. The livestock barn of claim 1, wherein the pit is at least partially filled with water to capture excrement and facilitate the movement of excrement.

6. The livestock barn of claim 1 further comprising a water system to flush the pit floor so that the excrement is forced toward the centerline.

7. The livestock barn of claim 6, wherein the water system at least partially fills the pit with water.

8. The livestock barn of claim 6, wherein the water system includes a plurality of jets to direct water toward the pit floor.

9. The livestock barn of claim 6, wherein the water system uses recycled water from the pit.

10. The livestock barn of claim 1, wherein each of the first portion of the pit floor and the second portion of the pit floor is separated into a plurality of sections, wherein each section is separated into a plurality of bays, wherein each bay is separated into a plurality of channels.

11. The livestock barn of claim 10 further comprising a water system having a plurality of jets, wherein at least one jet is directed toward each channel within the pit.

12. The livestock barn of claim 1 further comprising an attic positioned above the pen, wherein the attic houses an air circulation system.

13. A method of cleaning a livestock barn having a pit for capturing excrement and having a pit floor extending between a first end of the pit and a second end of the pit and extending between a first side of the pit and a second side of the pit to define a bottom of the pit, wherein a centerline extends along the bottom of the pit between the first end and the second end and is substantially equidistant from the first side and the second side, the method comprising:
sloping a first portion of the pit floor downward from the first side to the centerline so that excrement on the first portion of the pit floor is directed toward the centerline;
sloping a second portion of the pit floor downward from the second side to the centerline so that excrement on the second portion of the pit floor is directed toward the centerline; and
sloping the pit floor downward from the first end to the second end so that excrement on the centerline is directed from the first end to the second end.

14. The method of claim 13 further comprising:
extending a drainpipe along the centerline; and
spacing valves at intermittent positions along the drainpipe between the first end and the second end so that excrement directed toward the centerline is directed into the drainpipe via the valves, and wherein excrement directed from the first end to the second end is directed through the drainpipe to an outlet at the second end.

15. The method of claim 14 further comprising:
actuating the valves between an open position and a closed position; and
directing excrement into the drainpipe when the valve is in the open position.

16. The method of claim 14 further comprising:
fluidly coupling a collection tank to the outlet of the drainpipe; and
collecting excrement from the drainpipe in the collection tank.

17. The method of claim 13 further comprising at least partially filling the pit with water to capture excrement and facilitate the movement of excrement.

18. The method of claim 13 further comprising flushing the pit floor with a water system so that the excrement is forced toward the centerline.

19. The method of claim 18 further comprising at least partially filling the pit with water from the water system.

20. The method of claim 18 further comprising directing water toward the pit floor with a plurality of jets within the water system.

21. The method of claim 18 further comprising utilizing recycled water from the pit with the water system.

22. The method of claim 13 further comprising:
separating each of the first portion of the pit floor and the second portion of the pit floor into a plurality of sections;
separating each section into a plurality of bays; and
separating each bay into a plurality of channels.

23. The method of claim 22 further comprising directing at least one jet from a water system having a plurality of jets toward each channel within the pit.

24. A method for processing a slurry of water and solids, comprising:
grinding the slurry to reduce a particle size of the solids;
separating the water and solids to create separated water and separated solids;
adding microbes to the separated water;
pulverizing the separated solids to create pulverized solids;
mixing the pulverized solids with supplementary enhancements to create mixed solids;
pulverizing the mixed solids to create a powder; and
mixing the powder with at least one of supplements, bio-char, microbes, and mycorrhizae to create a soil supplement.
